(19) United States
(12) Patent Application Publication
(10) Pub. No.: US 2004/0063851 A1
(43) Pub. Date: Apr. 1, 2004

(54) Acrylate-based coating composition containing fluoromodified polymers

(76) Inventors: Bernhard Neppl, Koln (DE); Johannes Boysen, Koln (DE)

Correspondence Address: FISH & RICHARDSON PC, 225 FRANKLIN ST, BOSTON, MA, 02110, US

(21) Appl. No.: 10/433,248

(22) PCT Filed: Nov. 30, 2001
(86) PCT No.: PCT/DE01/04479

(30) Foreign Application Priority Data
Nov. 30, 2000 (DE) 100 59 853.6

(51) Int. Cl. B05D 3/02; B05D 1/36; C08K 3/00

(52) U.S. Cl. 524/589; 427/407.1; 427/385.5

(57) ABSTRACT

Coating composition obtainable by polyaddition of a non-aqueous starting mixture, comprising:

(1) 10 wt. % to 70 wt. % of a non-aqueous solution of a polymer based on acrylate with an OH number between 100 and 250;

(2) 10 wt. % to 70 wt. % of a non-aqueous solution of a fluorine-modified polymer having a glass transition temperature between 20 and 40° C. and

(3) 20 wt. % to 60 wt. % of at least one blocked aliphatic or cycloaliphatic polyisocyanate; the weight ratio of component (1) to component (2) amounting to at most 1 and the sum of components (1), (2) and (3) amounting to 100%, based on the binder content of the starting mixture to be crosslinked, and use of this coating composition as clear coat, in particular in the automotive industry.

The present invention relates to a coating composition layer, which is suitable in particular for the production of clear coat layers in the automotive industry.

In addition to having decorative properties such as imparting color, gloss, etc., coating of motor vehicles fulfills protective functions in particular with regard to a wide variety of environmental and weather influences, such as acid rain, UV radiation, etc. However, preventing corrosion of the metal by means of the coating film is of primary concern, whereby the protective function of the coating film should be guaranteed even under adverse circumstances such as UV radiation, impact of stones, mechanical effects (vehicle wash facilities), etc.

These increased requirements have resulted in the use of multilayer coatings in the automotive industry.

The most commonly used multilayer coating is the so-called four-layer coating described below, consisting of four coating layers, each having a different composition and method of application:

The first layer applied directly to the pretreated automobile sheet metal is a layer applied electrophoretically (electrocoat layer, cathodic dip coating layer) which is applied by electrodeposition coating—mainly cathodic dip coating (CDC)—for the purpose of preventing corrosion and subsequently baked on.

The second layer applied on top of the electrocoat layer and approximately 20 to 40 μm thick is a so-called primer layer which, on the one hand, provides protection against mechanical attack (function of protecting from impact of stones) while, on the other hand, it smoothes the rough surface of the automobile body for subsequent top coating, fills minor irregularities and protects the electrophoretically deposited layer (cathodic dip coating layer) from natural UV radiation. This layer is created largely by applying a baked-on coating, e.g. by electrostatic high rotation bells and subsequent baking at temperatures above 130° C.

The third layer applied on top of the primer layer is the so-called base-coat layer, which imparts the desired color to the vehicle body by appropriate pigments. The base coat is applied by the conventional spray method. The layer thickness of this conventional base-coat layer is approximately 12 to 25 μm, depending on the tint. In most cases, this layer is applied in two process steps, e.g. in a first step by application by means of electrostatic high rotation bells followed by a second application by means of pneumatic atomization. This layer is subsequently subjected to intermediate drying with infrared lamps and/or hot air convection.

The fourth and top-most layer applied on top of the base-coat layer is the clear coat layer, which is usually applied in one operation by means of electrostatic high-rotation bells. It imparts the desired gloss to the vehicle body and protects the base-coat from environmental effects (UV radiation, salt water, etc.). The layer thickness is usually between 30 and 50 μm. Subsequently, the base-coat layer and the clear coat layer are baked jointly at a temperature between 130° C. and 160° C.

A major disadvantage in the production of this four-layer coating is that it is equipment-intensive and therefore cost-intensive because of the different application methods used. In addition, the use of coatings for the spray application is no longer appropriate for reasons of environmental policy because considerable quantities of overspray arise during such coating operations. Moreover, because of the shape of the vehicle body, differences in tint and different top-coat states may be observed, which cannot be prevented in conjunction with the multilayer system described above.

The automotive industry therefore endeavors to replace the parts of the sheet metal outer of the vehicle body which must be coated, e.g. the bonnet, the boot cover, doors, etc. by parts already fully coated in the color of the vehicle to minimize the disadvantages described above.

An important prerequisite for this process is the use of so-called precoated coils. These coils of metal precoated in the color of the vehicle which can be converted to the desired shape by the automobile manufacturer by appropriate shaping methods (deep drawing) in the coated state. No additional coating is thus is necessary.

A major disadvantage of the precoated coils used in the past is that even before shaping, the coating structure does not conform to the properties required by the automotive industry with regard to gloss and appearance.

Furthermore, it was impossible to reproduce the tints demanded by the automotive industry. In particular in the case of effect coatings, the development of roller structures visible to the naked eye could not be prevented when using precoated coils. Furthermore, the development of an effect (flop effect) in the mass-produced coating could not be repeated. These are the main reasons why coils precoated in the color of the vehicle are not being used for mass production of motor vehicles.

The latest developments in the automotive industry are moving increasingly in the direction of modular design, where the automobile manufacturer simply fits the modules manufactured by outside companies to the motor vehicle. The term “module” should be understood to refer to such parts of the motor vehicle which are prefabricated by a supplier for the automobile manufacturer and are completely functional when taken alone. Examples of this include ready-to-install seats, fully wired dashboards etc.

Because of the available coating technology, it has not been possible so far to market body parts pre-coated in the color of the vehicle or outer shell modules.

Furthermore, it is known that compounds comprising fluorine can be used in coating compositions. For example, U.S. Pat. No. 5,948,851 describes a 2-component system which is crosslinked only at low temperatures. To do so, a mixture of an acrylic polymer with a special polyester comprising fluorine with a weight-average molecular weight of less than 15,000 and free polyisocyanate as the crosslinking agent is used as a binder. This mixture is applied wet-in-wet as a clear coat to a base-coat and the two layers are baked together at 83° C.

In addition, U.S. Pat. No. 5,169,915 describes a copolymer comprising fluorine which is also used in mixture with free isocyanates to form coatings which crosslink rapidly even at room temperature.

In addition, U.S. Pat. No. 5,929,158 describes the production of a copolymer comprising fluorine which can be obtained by free radical polymerization of an acrylic monomer in a fluoropolymer which is in solution.

However, such 2-component coatings which are known from coating automobile body are not suitable for producing coil coatings which are baked at high temperatures. Instead, crosslinking of these coatings can be observed as early as in the coating facilities (coaters) because their pot life is too short.

The object of the present invention is to provide a coating composition which is suitable for the production of precoated metal coils from which parts for motor vehicles can be manufactured by appropriate shaping methods (deep drawing). For this purpose, this coating composition should be suitable in particular for the production of coils precoated in the color of the vehicle which conform to the properties required by the automotive industry with respect to gloss and appearance.

This object is achieved by a coating composition obtainable by the polyaddition of a non-aqueous starting mixture, comprising:

(1) 10 wt. % to 70 wt. % of a non-aqueous solution of a polymer based on acrylate with an OH number between 100 and 250;

(2) 10 wt. % to 70 wt. % of a non-aqueous solution of a fluorine-modified polymer having a glass transition temperature between 20° C. and 40° C. and

(3) 20 wt. % to 60 wt. % of at least one blocked aliphatic or cycloaliphatic polyisocyanate;

the weight ratio of component (1) to component (2) amounting to at most 1, and the sum of components (1), (2) and (3) amounting to 100%, based on the binder content of the starting mixture to be crosslinked.

With the coating composition according to the invention, it is possible for the first time to provide metal coils precoated in the color of the vehicle which can be used for the production of automobile body outer shell parts or corresponding modules which satisfy the requirements of the automotive industry with regard to appearance and color. In addition, the coating composition according to the invention also satisfies the other requirements regarding a automobile series coating such as mechanical resistance to stress.

Very good results with respect to gloss are achieved with such a coating composition according to the invention in which component (1) is obtainable by radical polymerization of a monomer mixture comprising the following components:

(i) 30 wt. % to 60 wt. % of at least one polycycloaliphatic compound with at least two rings and a refractive index of at least 1.460 at 20° C.;

(ii) 25 wt. % to 70 wt. % of at least one C₂-C₄ hydroxyalkylacrylate and/or C2-C4 hydroxyalkyl (meth)acrylate with primary hydroxyl groups;

(iii) 0.1 to 1 wt. % acrylic acid;

the sum of components (1), (2) and (3) amounting to 100 wt. %, based on the monomer mixture. When using this special non-aqueous solution of a polymer based on acrylate, the other properties of a coating film obtained by crosslinking a corresponding coating composition are not impaired; in particular its mechanical properties (resistance to impact by stones, hardness and flexibility) and its resistance to chemicals satisfy the high requirements of the automotive industry with respect to a clear coat.

A polycycloaliphatic substance comprising a carboxyl group is understood in the context of the present invention to refer to a substance or a compound which has a polycarboxylic structure or substructure, i.e., the rings are only carbocycles.

The designation (meth) in (meth)acrylic as used here and below indicates that it includes both the methacrylic compounds and the acrylic compounds.

With regard to the relationship between refractive index and gloss, reference is made to the article by Juergen H. Braun in Journal of Coatings Technology, Vol. 63, No. 799, August 1991. With respect to the relationship between the refractive index and temperature, reference is made to Organikum, Autorenkollektiv [Organic Chemistry, various authors], VEB Deutscher Verlag der Wissenschaften, 16th edition, Berlin 1986, p. 76 f.

For substances which are not liquid at 20° C., the refractive index can be determined at an elevated temperature by using a thermostatically regulated Abbé refractometer with the light of the sodium D line λ=589 nm. The increment used for correction of temperature is: addition of 5·10-4 units per ° C.

Radical polymerization of component (1) is a current method with which those skilled in the art are familiar.

The monomer mixture used in the coating composition may additionally comprise 5 wt. % to 25 wt. % of a vinyl ester of a branched monocarboxylic acid having an average of 9 carbon atoms. Such vinyl esters are conventional commercial products and are available, e.g. under the brand name VeoVa9 from Shell. The use of such vinyl esters is advantageous when high demands are made of the hardness and resistance to chemicals.

Especially good results are achieved when isobornyl methacrylate is used as the polycycloaliphatic compound.

The coating films resulting from a coating composition obtainable in this way have excellent properties with regard to gloss and resistance to chemicals.

Likewise, very good results can be observed when the polycycloaliphatic compound of component (i) is selected from an acrylic copolymer obtainable by modifying an acrylic copolymer having at least one epoxy group with a polycycloaliphatic substance having at least two rings and one carboxyl group with a refractive index of at least 1.460 at 20° C., the epoxy group originating from glycidyl methacrylate. This special polycycloaliphatic compound of component (i) may be used alone or in mixture with other polycycloaliphatic compounds to produce a non-aqueous solution of a polymer based on acrylate. The use of such a polycycloaliphatic compound having a glycidyl methacrylate radical in mixture with isobornyl methacrylate is preferred.

In another embodiment according to the invention, the molar ratio of carboxyl group to epoxy group is between 0.5 and 1.0, preferably between 0.8 and 1.0, especially preferably between 0.9 and 1.0. The polycycloaliphatic substance comprising a carboxyl group, however, may also be a reaction product of at least two compounds; in particular component (i) is one of the above-mentioned polycycloaliphatic compounds which has been additionally reacted further at elevated temperature with polycarboxylic acids and/or their anhydrides to form a half-ester. In another embodiment according to the invention, the substance comprising a carboxyl group may have a refractive index of at least 1.480 at 20° C.

In this way, further improvements can be achieved with regard to the gloss of the finished clear coat layer without any negative effect on the other properties.

Especially suitable polycycloaliphatic compounds may include tricycloaliphatic monocarboxylic acids from the group of hydrogenated natural resin acids, e.g. commercial products such as Foral AX-E from the company Hercules BV, adamantane carboxylic acids; and tricyclic monocarboxylic acids derived from dicyclopentadiene such as tricyclodecane derivatives with a carboxyl group (TCD carboxylic acids), in particular tricyclo-[5.2.1.0.^{2,6}]decane-8 carboxylic acid, preferably tetrahydroabietic acid.

In another preferred embodiment of this invention, the polycycloaliphatic substance comprising a carboxyl group may be a reaction product of at least two compounds, at least one of which is a polycycloaliphatic compound having a refractive index of at least 1.460, preferably at least 1.480, at 20° C. In particular, at least one of the polycycloaliphatic compounds having a refractive index of at least 1.460 or 1.480 at 20° C. may be comprised in an amount of at least 10 wt. %, preferably at least 20 wt. %, and in particular at least 50 wt. %, in the reaction product comprising a carboxyl group.

In particular, a tricycloaliphatic monoalcohol from the group of perhydrogenated natural resins such as perhydroabietyl alcohol; the dicyclopentadiene derivatives e.g. 8-hydroxytricyclo[5.2.1.0.^{2,6}]decane, 8-hydroxymethyltricyclo[5.2.1.0.^{2,6}]decane, 8-hydroxytricyclo[5.2.1.0.^{2,6}]dec-3-ene, 9-hydroxytricyclo[5.2.1.0.^{2,6}]dec-3-ene is suitable as polycycloaliphatic compound. This monoalcohol reacts with a compound comprising a carboxyl group to form a half-ester during the production of the polycycloaliphatic substance comprising a carboxyl group. Suitable compounds comprising a carboxyl group for this purpose are, in particular, dicarboxylic acids or their anhydride(s), for example from the group of succinic acid (anhydride), glutaric acid (anhydride), quinoline dicarboxylic acid (anhydride), furandicarboxylic acid (anhydride), pyridine dicarboxylic acid (anhydride), phthalic acid (anhydride), hexahydrophthalic acid (anhydride), tetrahydrophthalic acid (anhydride), methyl hexahydrophthalic acid (anhydride), naphthalene dicarboxylic acid (anhydride) and maleic acid (anhydride).

The term “(anhydride)” as used here and below indicates that both the free acid and its anhydride are meant.

If the polycycloaliphatic compound to be used as the starting material for the reaction product is a polycycloaliphatic dicarboxylic acid or possible anhydride(s) thereof, such as e.g. those from the group of hydrogenated natural resin acids, adamantane carboxylic acids and tricyclic monocarboxylic acids derived from dicyclopentadiene, e.g. tricyclo[5.2.1.0.^{2,6}]decane-8 carboxylic acid, preferably tetrahydroabietic acid, then the alcohol may also be an aliphatic monohydric alcohol, e.g. methanol, ethanol, n-propanol, isopropanol, methoxypropanol, n-butanol, isobutanol, 2-ethyl-1-hexanol, 1-hexanol, a heptyl alcohol, a nonyl alcohol; a fatty alcohol, e.g. octanol, decanol, dodecanol, a glycol monoether, e.g. methyl glycol, ethyl glycol, butyl glycol, polyglycol monoether; an aromatic monohydric alcohol, e.g. benzyl alcohol; or a cycloaliphatic monohydric alcohol, e.g. cyclohexanol, cyclododecanol and/or cyclopentanol. Here again, the reaction product is a half-ester, which is subsequently polymerized with the epoxy group originating from the glycidyl methacrylate.

However, the polycycloaliphatic substance comprising a carboxyl group may also comprise one or more aromatic compounds. This option will be selected when the gloss of the finished clear coat layer is to be increased even further. Such an aromatic compound may preferably originate from the group of aromatic monocarboxylic acids such as naphthoic acid, benzenemonocarboxylic acids such as benzoic acid, o-toluic acid, m-toluic acid, p-toluic acid, hydroxybenzoic acid, tert-butylbenzoic acid, aromatic heterocyclic monocarboxylic acids such as pyridine carboxylic acids and furancarboxylic acids.

According to an especially preferred embodiment, the C₂-C₄ hydroxyalkyl (meth)acrylate is selected from 2-hydroxyethyl (meth)acrylate and 4-hydroxybutyl (meth)acrylate.

Very good results are achieved with 2-hydroxyethyl methacrylate and 4-hydroxybutyl acrylate.

However, the invention is not limited to the use of C₂-C₄ hydroxyalkyl (meth)acrylates with primary hydroxyl groups. It is also possible to use C₂-C₄-hydroxyalkyl (meth)-acrylates in which up to 50% of the primary hydroxyl groups are replaced by secondary hydroxyl groups. Examples of C₂-C₄ hydroxyalkyl (meth)acrylates with secondary hydroxyl groups are 2-hydroxypropyl (meth)acrylate, 2-hydroxybutyl (meth)acrylate and hexanediol-1,6-mono(meth)acrylate.

All compounds which are in solution and not in the form of a dispersion under the reaction conditions are suitable for use as the fluorine-modified polymer. Examples of especially suitable fluorine-modified polymers are those based on fluorine-comprising vinyl ether with a fluorine content between 25% and 30%, a glass transition temperature between 16° C. and 45° C. and a hydroxyl value between 45 and 90. Such polymers are available commercially and are distributed, e.g. under the brand name “Lumiflon®” by the company Zeneca Resins.

The polycycloaliphatic substance comprising a carboxyl group may also additionally comprise one or more aromatic compounds, preferably from the group of aromatic polycarboxylic acids such as naphthoic acid, benzenemonocarboxylic acids such as benzoic acid, o-toluic acid, m-toluic acid, p-toluic acid, hydroxybenzoic acid, tert-butylbenzoic acid, aromatic heterocyclic monocarboxylic acids such as pyridine carboxylic acids and furancarboxylic acids.

If high demands are made regarding the resistance to weathering of the coating composition, no aromatic or heterocyclic monocarboxylic acids are used concurrently or the total amount of aromatic rings including vinyl aromatics, e.g. styrene, amounts to no more than 30 wt. %, based on the coating composition.

Component (i) can be obtained by reacting the starting compounds at an elevated temperature, e.g. 60° C. to 200° C., preferably 120° C. to 170° C. The reaction may be performed in the melt or in the presence of organic solvents such as those conventionally used in the production of paint or synthetic resins for paint, e.g. alcohols such as methoxy propanol, butanol, aromatic hydrocarbons, e.g. xylene, petroleum distillates based on alkylbenzenes, esters, e.g. butyl acetate, methoxypropyl acetate, ketones, e.g. butanone, methyl isobutyl ketone and mixtures thereof. If necessary, the conventional catalysts for catalyzing the epoxy/carboxy reaction may be used for this, e.g. alkali metal hydroxides, e.g. lithium hydroxide monohydrate, tertiary amines, e.g. triethylamine, N,N-benzylmethylamine, triethylbenzylammonium chloride, benzyltrimethylammonium chloride, as well as mixtures of different catalysts, usually in an amount of 0.1 to 2 wt. %, based on the total amount of the components. If the reactions are performed at an elevated temperature, e.g. 150° C. to 170° C., it is generally possible to omit catalysts. The modifying agents claimed may be added to the acrylic copolymer comprising epoxy groups before the reaction temperature or they may be added at the reaction temperature in portions gradually or continuously, taking into account the exothermic reaction, also in the form of solutions, e.g. in organic solvents if they are soluble in the solvent or form a stable dispersion. The amount of the polycycloaliphatic substance comprising a carboxyl group is selected, as mentioned above, so that the ratio of epoxy groups to carboxyl groups is usually 1:0.5 to 1:1 and depends mainly on the intended application and/or the use of the coating composition. The reaction is generally terminated as soon as the acid number has dropped below 20, preferably amounts to 0 to 10. However, acrylic copolymers having a higher acid number, e.g. 25 to 50 may also be produced.

The number-average molecular weight of component (i) may vary within wide limits and is preferably between 500 and 10,000, especially preferably between 700 and 5000, in particular 750 and 2000 (g/mole). The acid number is between 0 and 50, preferably between 5 and 25 (mg KOH/g resin).

In principle, all blocked polyisocyanates can be used as crosslinking agents in which the isocyanate groups have been reacted with a compound so that the blocked polyisocyanate formed is stable with respect to the hydroxyl groups of the polymer at room temperature but will react at an elevated temperature, usually in the range of approximately 90 to 300° C. Any organic polyisocyanates suitable for crosslinking can be used for the production of the blocked polyisocyanates. Isocyanates comprising approx. 3 to approx.36 carbon atoms, in particular approximately 8 to 15 carbon atoms, are preferred. Examples of suitable diisocyanates are the diisocyanates listed above. Polyisocyanates with a higher isocyanate functionality may also be used. Examples include tris-(4-isocyanatophenyl)methane, 1,3,5-triisocyanatobenzene, 2,4,6-triisocyanatotoluene, 1,3,5-tris-(6-isocyanatohexyl)biuret, bis-(2,5-diisocyanato-4-methylphenyl)methane and polymeric polyisocyanates such as dimers and trimers of diisocyanatotoluene. Furthermore, mixtures of polyisocyanates may also be used. The organic polyisocyanates that may be used as crosslinking agents in this invention may also be prepolymers which are derived from a polyol, for example, including a polyether polyol or a polyester polyol. To do so, it is known that polyols are reacted with an excess of polyisocyanates, thus forming prepolymers with terminal isocyanate groups. Examples of polyols that may be used for this purpose are simple polyols, e.g. glycols such as ethylene glycol and propylene glycol and other polyols such as glycerol, trimethylolpropane, hexanetriol and pentaerythritol; also monoethers such as diethylene glycol and dipropylene glycol as well as polyethers which are adducts of such polyols and alkylene oxides. Examples of alkylene oxides suitable for polyaddition onto these polyols to form polyethers include ethylene oxide, propylene oxide, butylene oxide and styrene oxide. These polyaddition products are generally referred to as polyethers with terminal hydroxyl groups. They may be linear or branched. Examples of such polyethers are polyoxyethylene glycol with a molecular weight of 1540, polyoxyproylene glycol with a molecular weight of 1025, polyoxytetramethylene glycol, polyoxyhexamethylene glycol, polyoxynonamethylene glycol, polyoxydecamethylene glycol, polyoxydodecamethylene glycol and mixtures thereof. Other types of polyoxyalkylene glycol ethers may also be used. Particularly suitable polyether polyols are those obtained by reacting such polyols as ethylene glycol, diethylene glycol, triethylene glycol, 1,4-butanediol, 1,3-butanediol, 1,6-hexanediol and mixtures thereof; glycerol, trimethylolethane, trimethylolpropane, 1,2,6-hexanetriol, dipentaerythritol, tripentaerythritol, polypentaerythritol, methyl glycosides and sucrose with alkylene oxides such as ethylene oxide, propylene oxide or mixtures thereof. Any suitable aliphatic, cycloaliphatic or aromatic alkyl monoalcohols may be used for blocking the polyisocyanates. Examples in this respect are aliphatic alcohols such as methyl alcohol, ethyl alcohol, chloroethyl alcohol, propyl alcohol, butyl alcohol, amyl alcohol, hexyl alcohol, heptyl alcohol, octyl alcohol, nonyl alcohol, 3,3,5-trimethylhexyl alcohol, decyl alcohol and lauryl alcohol; aromatic alkyl alcohols such as phenylcarbinol and methyl phenylcarbinol. Small amounts of higher molecular weight monoalcohols having a relatively low volatility may also be used if necessary, these alcohols acting as plasticizers in the coatings after they are split off. Other suitable blocking agents are oxime such as methyl ethyl ketone oxime, acetone oxime and cyclohexanone oxime as well as caprolactams, phenols and hydroxamic acid esters. Preferred blocking agents include malonic ester, acetoacetate ester and β-diketones. Methyl ethyl ketoxime and caprolactam are especially preferred. The blocked polyisocyanates are produced by reacting the capping agent in a sufficient quantity with the organic polyisocyanate so that there are no longer any free isocyanate groups present. The blocked aliphatic or cycloaliphatic polyisocyanate is preferably a blocked isophorone diisocyanate (IPDI, 3,5,5-trimethyl-1-isocyanato-3-isocyanatomethylcyclohexane) present in trimerized or biuret form and/or 2,4,6-trioxo-1,3,5-tris(6--isocyanatohexyl)hexahydro-1,3,5-triazine (Desmodur®) N3300).

However, other suitable polyisocyanates may also be used, e.g. 1,3-bis(1-isocyanato-1-methylethyl)benzene (TMXDI, m-tetramethylxylylene diisocyanate) or 4,4′-dicyclohexylmethane diisocyanate (Desmodur® W). The latter polyisocyanates must also be reacted with suitable blocking agents. The choice of suitable blocking agent depends on the crosslinking temperatures. When using the coating composition according to the invention as a coil coating paint, methyl ethyl ketoxime or caprolactam is usually selected as the blocking agent.

However, there are also commercial blocked polyisocyanates such as for example those brought on the market by Bayer under the trade name Desmodur® BL 3175.

The aforementioned coating composition also additionally comprises, in addition to the obligatory components, the solvents conventionally used in solution polymerization of acrylic copolymers and in the production of baked-on coatings, such as aromatic hydrocarbons, e.g. xylene, esters, e.g. methoxypropyl acetate, ketones, e.g. butanone, methyl isobutyl ketone, alcohols, e.g. butanol, methoxypropanol, glycol monoethers, e.g. butyl glycol, and mixtures thereof, e.g. mixtures of primarily aromatic petroleum distillate solvents having a higher boiling point and butanol, and they can be diluted to the application viscosity with these solvents or solvent mixtures.

The coating composition according to the invention may optionally additionally comprise the usual additives and auxiliary substances for the production of coatings, e.g.:

surfactants, e.g. wetting agents and flow control agents based on silicone, e.g. polyether-modified dimethylpolysiloxane copolymers, fluorosurfactants;

rheological aids, e.g. anti-sagging agents (SCA-modified acrylic copolymers; SCA=sagging control agents);

thickeners or thixotropy agents, highly-dispersed silica, polyurethanes, high-viscosity acrylic copolymers with acrylic acid and/or methacrylic acid as the main effective copolymerising component; acid catalysts, e.g. phosphoric acid, acid half-esters of phosphoric acid with monohydric or dihydric alcohols, e.g. phosphoric acid monobutyl ester, half-esters of dicarboxylic acids and/or the anhydrides thereof with monohydric alcohols, e.g. maleic acid monobutyl ester, solutions of polyacids in suitable organic solvents, e.g. 20% solutions of maleic acid in methoxypropanol;

accelerators, e.g. tertiary amines, e.g. triethylamine, dibutyltin dioxide, dibutyltin dilaurate, metal alcoholates, e.g. aluminum isopropylate, butyl titanate, metal chelates of aluminum, zirconium or titanium, e.g. titanyl acetylacetonate;

light stabilizers, e.g. benzotriazole derivatives and HALS compounds (HALS=hindered amine light stabilizer);

additional crosslinking agents, in particular

carboxy-functional components, preferably polycarboxylic acids or the anhydrides thereof, e.g. itaconic acid, citraconic anhydride, dodecanedioc acid, 2-dodecenedioic acid, dodecenylsuccinic anhydride, phthalic anhydride, tetrahydrophthalic anhydride, trimellitic anhydride, 1,2-, 1,3- and 1,4-cyclohexane dicarboxylic acid, hexahydrophthalic anhydride and/or mixtures thereof such as those generally used to harden polyepoxides, e.g. diepoxides based on bisphenol A, cycloaliphatic diepoxides, e.g. hexahydrophthalic acid diglycidyl ester, 3,4-epoxycyclohexylmethyl-3′,4′-epoxycyclohexane carboxylate, acrylic copolymers comprising epoxide groups, with more than one, preferably two or more epoxide groups per average molecular weight, or polyacids which are half-esters obtained by reacting a polyol, e.g. 1,6-hexanediol, trimethylolpropane, with an acid anhydride, e.g. hexahydrophthalic anhydride, methyl hexahydrophthalic anhydride, such as those described in European Patent A 212 457, and carboxy-functional acrylic copolymers, e.g. those produced by using substantial quantities of (meth)acrylic acid in the synthesis of acrylic copolymers, e.g. with an acid number of 70 or higher as well anhydride acrylic copolymers, e.g. those produced by using maleic anhydride and/or itaconic acid in the production of acrylic copolymers, as described in European Patents A 358 306, A 316 873, as well as unsaturated or saturated polyesters comprising carboxyl groups, in particular those with a high acid number, e.g. 70 or more and/or

aminoplastic substances which have satisfactory compatibility in terms of coating technology with the modified acrylic copolymers, aminoplastics etherified preferably entirely or partially with monohydric alcohols, in particular C1-C4 alcohols, e.g. urea and/or triazine-formaldehyde resins, in particular melamine-formaldehyde resins, benzoguanamine resins, e.g. tetramethoxybenzoguanamine, triazine-formaldehyde resins produced according to unexamined German Patent 42 37 515, e.g. by reacting 2,4-diamino-6-diethylaminotriazine, paraformaldehyde and butanol, hexamethoxymethylmelamine, hexamethylbutoxymethylmelamine, tetramethoxymethylglycoluril; in particular derivatives comprising carboxyl groups and derived from partially or entirely etherified aminoplastics such as those described in Unexamined German Patent 35 37 855, U.S. Pat. No. 3,519,627, U.S. Pat. No. 3,502,557 and U.S. Pat. No. 4,026,855; or the aminoplastics mentioned in the relevant literature (Karsten, Enamel Raw Material Tables, 9th edition, Curt R. Vincentz Verlag, Hannover, 1992, pp. 269-288; European Resin Directory 1983, European Resin Manufacturers Association, pp. 101-108); and/or

TACT (tris(alkoxycarbonylamino)-1,3,5-triazines) such as tris(methoxycarbonylamino)-1,3,5-triazine, tris(butoxycarbonylamino)-1,3,5-triazine or mixtures thereof.

other binder components, preferably resins which are satisfactorily compatible with the coating composition according to the invention from the standpoint of coating technology, in particular acrylic copolymers comprising carboxyl groups and hydroxyl groups and/or saturated or unsaturated polyesters comprising carboxyl groups and hydroxyl groups in subordinate amounts (1 to 30 wt. %), based on solid binder.

The solids content of this coating composition in a ready-to-use form preferably amounts to at least 45 wt. %, in particular 50 wt. % or more.

The use of the coating composition according to the invention as a non-aqueous or solvent-dilutable clear coat and/or glazing top-coat coating is especially preferred, particularly in the automotive industry.

The coating composition may be used in particular for coating precoated metal coils (coil coating). The application of the coating composition is effected in this case by using coating methods with which those skilled in the art are familiar. Particularly suitable methods include the rolling method and the casting head method.

With regard to the use of the coating composition as a clear coat for the production of precoated metal coils, the coating composition according to the invention is used in multilayer coating. Such a multilayer coating suitable for the automotive industry is obtainable e.g. by the following procedure:

applying a primer layer to a pretreated metallic substrate and baking the same at a temperature between 180 and 260° C.;

applying a color-imparting base-coat layer and baking the same at a temperature between 180 and 260° C.;

applying a coating composition according to one of claims 1 to 19 and baking it at a temperature between 180 and 260° C.

The coating agents that can be used to produce a primer layer and a base-coat layer in the aforementioned multilayer coating are available commercially, e.g. under the trademark Polycoat® CC-Primer from the company Bollig & Kemper. The layer thicknesses of such as a multilayer coating, i.e., the thickness of the primer layer, the base-coat layer and the clear coat layer obtainable form the coating composition in the crosslinked state are between 10 and 25 μm respectively. Very uniform layer thicknesses are obtained by applying the individual layers by the so-called coil coating method. This yields a particularly uniform observable effect when using base-coats comprising effect pigments; such an effect could not be achieved in the past by spray application of a base-coat. The minor unavoidable differences in layer thickness which occur with a spray application are manifested in a difference in effect which is clearly observable visually.

The coating composition in the present case is especially preferably suitable for the production of automobile parts by deep drawing the metal coils precoated in the color of the vehicle since the clear coat layer according to the invention is characterized in particular by excellent deep drawing properties without any negative effect on the over-all level of properties of the crosslinked coating. This possibility opens up new fields of application for automobile manufacturers, in particular new possibilities in the field of coloristics.

The following examples serve to illustrate the invention.

### EXAMPLES

Production of a Cycloaliphatic Acrylate Polymer According to the Invention

Into a 2-liter four-necked, round bottomed flask equipped with a heating device, thermometer, agitator, cooling attachment and gas inlet tube, 328.5 g Solvesso® 100, 87.6 g Veova® 9 and 5.8 g cumene hydroperoxide (80% delivery form in a ketone mixture) are placed as starting materials. While stirring and passing nitrogen through the mixture, it is heated to 140° C., and using a dripping funnel, a mixture of 284.5 g isobornyl methacrylate, 206.3 g 2-hydroxymethyl methacrylate, 2.3 g acrylic acid, 43 g ethyl-3,3-di(tert-amylperoxy)butyrate and 14.0 g Solvesso® 100 is metered in uniformly within four hours. One hour after the end of this addition, a mixture of 4 g ethyl-3,3-di(tert-amylperoxy)butyrate and 24.0 g Solvesso® 100 is added dropwise within 30 minutes. After another two hours, the mixture is cooled to 80° C. and filtered through a 30 μm screen. The resulting resin has an acid number of 4 mg KOH/g, a solids content of 60 % and a viscosity of 40 to 60 seconds, measured according to DIN 53211 in a 4 mm beaker at 20° C. (50% in Solvesso® 100).

### EXAMPLE

In a 2-liter metal mixing vessel, 360 g of the acrylic copolymer described above are mixed with 140 g of a commercial fluoropolymer resin (Lumiflon® LF 552 from Zeneca Resins, a 60% solution in aromatic solvents). Subsequently, 150 g of a commercial aliphatic polyisocyanate blocked with ketoxime (Desmodur® BL 3175 from Bayer AG), 175 g of a commercial blocked cycloaliphatic polyisocyanate (Vestanat® B 1370 from Degussa Hüls AG), 20 g of a UV absorber based on benzotriazole (Tinuvin® 1130 from Ciba Spezialitaten Chemie), 10 g of a HALS compound (Tinuvin® 292 from Ciba Spezialitaten Chemie), 3 g of a flow control agent based on acrylic copolymer (Disparlon® L1984 from Kusumoto Chemicals), 2 g dibutyltin dilaurate and 40 g butyl diglycol acetate are added. By adding 10.0 parts by weight Solvesso® 150, the processing viscosity is adjusted to 80 seconds in the 4 mm DIN beaker at 20° C.

### COMPARATIVE EXAMPLE

In a 2 l metal mixing vessel, 700 g of a commercial fluoropolymer resin (Lumiflon® LF 552 from Zeneca Resins, 60% solution in aromatic solvents) are mixed with 150 g of a commercial blocked cycloaliphatic polyisocyanate (Vestanat® B 1370 from Creanova), 15 g of a UV absorber based on benzotriazole (Tinuvin® 1130 from Ciba-Geigy), 8 g of a HALS compound (Tinuvin® 292 from Ciba Spezialitaten Chemie), 5 g of a flow-control agent based on an acrylic copolymer (Disparlon® L1984 from Kusumoto Chemicals) and 2 g dibutyltin dilaurate. The processing viscosity is set at 80 seconds in the 4 mm DIN beaker at 20° C. by adding 119 g Solvesso® 150.

Production of a Base-Coat

560 g of a commercial polyester resin (Dynapol® LH830 from Degussa Huls AG, 60% dissolved in Solvesso® 150) are placed in a 2-liter metal mixing vessel. With the help of a suitable dispersing device (dissolver from Pendraulik), 5 g colloidal silica (Aerosil® R972 from Degussa AG) are dispersed. Adding 90 g of a commercial blocked aliphatic polyisocyanate (Desmodur® BL 3175 from Bayer AG) is done while stirring, the addition of 5 g of a flow control agent based on acrylic copolymer (Disparlon® L1984 from Kusumoto Chemicals) and 2 g dibutyltin dilaurate (reaction accelerator) and 50 g Solvesso® 200S. Then 90 g aluminum effect pigment (Alpate® 8160 from Alcan Toyo) is prepared to a paste in 100 g Solvesso® 150 and added to the mixture described above after one hour. The viscosity is adjusted to a value between 90 and 100 seconds (measured in the 4 mm DIN beaker at 20° C.) with approximately 9.8 parts by weight Solvesso® 150.

Production of the Test Panels (Multilayer Coating)

Chromated aluminum sheet metal conventionally used in the coil coating industry, having a sheet metal thickness of 0.58 mm and coated with a commercial anti-corrosion primer suitable for deep drawing Polycoat® 21-209-9544 CC-Primer from Bollig & Kemper) with a film thickness of 15 μm, is used as substrate for the application of the coating composition according to the invention. The base-coat prepared previously is applied to this primer layer so as to yield a dry layer thickness of 15 μm. The base-coat layer is dried at a PMT (peak metal temperature) of 249° C. Subsequently, a clear coat produced according to this example and the reference example is applied to this base-coat layer so that in the crosslinked state a clear coat layer with a dry layer thickness of 15 μm is obtained. This clear coat layer is also hardened at a PMT of 249° C. The resulting multilayer coatings are tested for the following properties according to the test methods described below: adhesion, gloss, pencil hardness, cracking after bending, resistance to chemicals, waviness and Knoop hardness. Table I shows the results of these tests.

Testing the Gloss:

The gloss was determined according to the standards DIN 67,539, ISO 2813 and ASTM D-523 using a gloss meter from the company Byk-Gardner at a measurement angle of 20°.

Testing of the Pencil Hardness:

The coating surface is scratched at an angle of 45° with the help of pencils of increasing hardness. The hardness corresponds to that of the hardest pencil which will no longer penetrate into the surface of the coating. A set of pencils with the following degrees of hardness is used:

6B-5B-4B-3B-2B-B-HB-F-H-2H-3H-4H-5H -6H.

This test is usually performed by hand, but a mechanical device may also be used in which a force of 7.5 Newtons should be applied to the pencil. This test is described in detail under ECCA-T4 in the ECCA test methods. The reference standards for this are: ISO 3270-1984/ASTM D-3363-1974 (reapproved 1980).

Testing for Cracking After Bending (T-Bend Test):

The coated sheet metal panel is bent 360° so that the coating film is facing outwards. Then it is clamped in a vice and pressed together tightly at the bending point (=>T0). Using a magnifying glass with a tenfold magnification, the bend is examined for cracks. If cracks can be detected, the panel is bent around itself, so that the radius of the bend is increased by the thickness of the panel (=>T1). This procedure is repeated until no more damage occurs. With each bending operation, the T value is increased by 0.5. The T value at which no more cracks can be detected is indicated. This test is described in detail under ECCA-T7 in the ECCA test methods. The reference standards for this are: EN2370:1991/EN ISO 1519:1995/EN ISO 6860:1995/ASTM D 5220-93a.

Testing of the Resistance to Chemicals of Coating Surfaces by Using a Gradient Oven:

A gradient oven developed by the company Byk-Mallinckrodt is used to heat, by means of a microprocessor-supported control, a single test sheet which has been coated with the multilayer coating to be tested in such a way that, after the end of the baking operation, a continuous range of selectable temperatures for physical tests is available. Within a working range of +50° C. to +250° C., up to four different heating zones with a constant temperature may be set as desired.

To test for resistance to chemicals, the following procedure is used:

The gradient sheet metal is coated with the paint to be tested and baked.

The test chemicals (in line with the client specification) are applied to the coating film in rows of equal distance. Up to five chemicals may be applied to the sheet metal at the same time.

The test sheet is placed in the gradient oven, which has been preheated (client specifications) and this is closed.

After a treatment time of 30 minutes (client specification), the oven is opened and the temperature zones are printed out.

The sheet metal removed from the oven is cleaned under running water (client specification) and then evaluated.

The evaluation is performed once immediately and/or after 24 hours (client specification).

The assessment can take place according to different methods (client-specific):

in five categories: satisfactory, slightly swollen, swollen, coating damaged/coating detached or

on the basis of the temperature at which no visible change in the coating surface subjected to stress can be discerned.

Examples of client specifications include the standard PA 15/050L of BMW and the standard PBODC 371 of Daimler Chrysler (Sindelfingen plant).

The Orange Peel Test (Waviness):

Wavy structures in the finished paint coat with a size of approximately 0.1 to 10 nm are referred to as orange peel.

Such effects are often evaluated visually, i.e., subjectively are described with terms such as “lumpy” or “grainy.” We see orange peel as a pattern of light and dark fields.

The recognizability of the structures depends on the observation distance.

Long waviness is discernible from a distance of approximately 3 m

* Short waviness is visible only at a short distance (approximately 50 cm)

To describe this effect in figures, the Wave-Scan plus from Byk-Gardner is used. The surface (wavy brightness pattern) is scanned optically using a laser point light source at an angle of 60° and a detector on the opposite side. The measuring device is moved over a distance of 10 cm and the optical brightness profile is measured from point to point. The measurement signal is divided into two components:

Long waviness (structures>0.6 mm)

Short waviness (structures<0.6 mm)

The values required by the automotive industry are:

Long waviness: 4-7 (very good)

Short waviness: 18-22 (very good)

Testing the Knoop Impression Hardness:

The hardness of an organic coating was determined by means of a small load hardness tester (Leitz Miniload) from the company Leitz. Plastic deformation of the coating is determined by measuring the length of impression caused by a tool (diamond tip) having a specified shape (rhomboid shape) and dimensions under defined test conditions (exposure time, weight, temperature, etc.).

The length of impression is inversely proportional to the hardness of the coating film, i.e., the smaller the impression the harder is the coating surface and the greater is the numerical value of the Knoop hardness.

Further details (formulae for calculation, etc.) for the test conditions can be found in the documents for the Knoop hardness tester from the company Leitz.

TABLE 1

| | Example | Comparison |
|---|---|---|
| Gloss | 82 | 73 |
| Long waviness | 7 | 10 |
| Short waviness | 23 | 31 |
| Knoop hardness | 23 | 18 |
| T-bend test | 1.5 | 1.5 |
| Chemical resistance | | |
| to tree resin (45° C.)* | 57° C. | 43° C. |
| to deionized water (>80° C.)* | >80° C. | 70° C. |
| to pancreatin (60° C.)* | 70° C. | 63° C. |
| to sulfuric acid 1% (56° C.)* | 60° C. | 75° C. |
| to sodium hydroxide solution 10% | >80° C. | >80° C. |
| (>80° C.)* | | |
| to fuel (OK)* | OK | swollen |

*Values in parentheses are conventional specifications from the automotive industry

Table I shows clearly that the coating composition according to the invention satisfies all the requirements of the automotive industry and is clearly superior to a clear coat according to the state of the art with regard to gloss and appearance.

1.) Coating composition obtainable by polyaddition of a non-aqueous starting mixture, comprising:
(1) 10 wt. % to 70 wt. % of a non-aqueous solution of a polymer based on acrylate with an OH number between 100 and 250;
(2) 10 wt. % to 70 wt. % of a non-aqueous solution of a fluorine-modified polymer having a glass transition temperature between 20 and 40° C. and
(3) 20 wt. % to 60 wt. % of at least one blocked aliphatic or cycloaliphatic polyisocyanate;
the weight ratio of component (1) to component (2) amounting to at most 1, and the sum of components (1), (2) and (3) amounting to 100%, based on the binder content of the starting mixture to be crosslinked.

2.) Coating composition according to claim 1, characterized in that component (1) is obtainable by radical polymerization of a monomer mixture comprising:
(i) 30 wt. % to 60 wt. % of at least one polycycloaliphatic compound with at least two rings and a refractive index of at least 1.460 at 20° C.;
(ii) 25 wt. % to 70 wt. % of at least one C₂-C₄ hydroxyalkyl(meth)acrylate with primary hydroxyl groups;
(iii) 0.1 to 1 wt. % acrylic acid;
the sum of components (1), (2) and (3) amounting to 100 wt. %, based on the monomer mixture.

3.) Coating composition according to claim 2, characterized in that the monomer mixture additionally comprises 5 wt. % to 25 wt. % of a vinyl ester of a branched monocarboxylic acid having an average of nine carbon atoms.

4.) Coating composition according to claim 2 or 3, characterized in that the polycycloaliphatic compound is isobornyl methacrylate.

5.) Coating composition according to one of claims 2 to 4, characterized in that the polycycloaliphatic compound of component (i) is selected from among an acrylic copolymer obtainable by modifying an acrylic copolymer having at least one epoxy group with a polycycloaliphatic substance comprising a carboxyl group and having at least two rings with a refractive index of at least 1.460 at 20° C., the epoxy group originating from glycidyl methacrylate.

6.) Coating composition according to claim 5, characterized in that the molar ratio of carboxyl group to epoxy group is between 0.5 and 1.0, preferably between 0.8 and 1.0, especially preferably between 0.9 and 1.0.

7.) Coating composition according to claim 6, characterized in that the polycycloaliphatic substance comprising a carboxyl group also comprises a polycycloaliphatic compound which has been reacted further at elevated temperature with polycarboxylic acids and/or their anhydrides to form a half-ester.

8.) Coating composition according to one of claims 5 to 7, characterized in that the substance comprising a carboxyl group has a refractive index of at least 1.480 at 20° C.

9.) Coating composition according to one of claims 5 to 8, characterized in that the polycycloaliphatic substance comprising a carboxyl group is a tricycloaliphatic monocarboxylic acid from the group of hydrogenated natural resin acids; adamantane-carboxylic acids and tricyclic monocarboxylic acids derived from dicyclopentadiene, e.g. tricyclo[5.2.1.0.^{2,6}]decane-8-carboxylic acid, preferably tetrahydroabietic acid.

10.) Coating composition according to one of claims 5 to 9, characterized in that the polycycloaliphatic substance comprising a carboxyl group is a reaction product of at least two compounds, at least one of which is a polycycloaliphatic compound having a refractive index of at least 1.460, preferably at least 1.480, at 20° C.

11.) Coating composition according to claim 10, characterized in that at least one of the polycycloaliphatic compounds having a refractive index of at least 1.480 at 20° C. is present in an amount of at least 10 wt. %, preferably at least 20 wt. %, and in particular at least 50 wt. % in the polycycloaliphatic reaction product comprising a carboxyl group.

12.) Coating composition according to claim 10 or 11, characterized in that the polycycloaliphatic compound is a tricycloaliphatic monoalcohol from the group of perhydrogenated natural resins such as perhydroabietyl alcohol; the dicyclopentadiene derivatives such as e.g. 8-hydroxytricyclo[5.2.1.0.^{2,6}]decane, 8-hydroxymethyltricyclo-[5.2.1.0.^{2,6}]decane, 8-hydroxytricyclo[5.2.1.0.^{2,6}]dec-3--ene, 9-hydroxytricyclo[5.2.1.0.^{2,6}]dec-3-ene.

13.) Coating composition according to one of claims 10 to 12, characterized in that the polycycloaliphatic compound is a dicarboxylic acid and its anhydride from the group of hydrogenated natural resin acids; adamantane-carboxylic acids; and tricyclic monocarboxylic acids derived from dicyclopentadiene such as tricyclo[5.2.1.0.^{2,6}]decane-8-carboxylic acid, preferably tetrahydroabietic acid.

14.) Coating composition according to one of claims 5 to 13, characterized in that the polycycloaliphatic substance comprising a carboxyl group additionally comprises. one or more aromatic compounds.

15.) Coating composition according to claim 14, characterized in that the aromatic compound is selected from the group of aromatic monocarboxylic acids such as naphthoic acid, benzenemonocarboxylic acid such as benzoic acid, o-toluic acid, m-toluic acid, p-toluic acid, hydroxybenzoic acid, tert-butylbenzoic acid, aromatic heterocyclic monocarboxylic acids such as pyridine carboxylic acids and furancarboxylic acids.

16.) Coating composition according to one of claims 2 to 15, characterized in that the C₂-C₄ hydroxyalkyl (meth)acrylate is selected from 2-hydroxyethyl (meth)acrylate and 4-hydroxybutyl (meth)acrylate.

17.) Coating composition according to one of claims 2 to 16, characterized in that up to 50% of the primary hydroxyl groups of the C₂-C₄ hydroxyalkyl (meth)acrylate are replaced by secondary hydroxyl groups.

18.) Coating composition according to claim 17, characterized in that the C₂-C₄ hydroxyalkyl (meth)acrylate is selected from 2-hydroxypropyl (meth)acrylate, 2-hydroxybutyl (meth)acrylate and hexanediol-1,6-mono(meth)acrylate.

19.) Coating composition according to one of the preceding claims, characterized in that the fluorine-modified polymer is a polymer based on fluorine-comprising vinyl ether with a fluorine content between 25% and 30%, a glass transition temperature between 16° C. and 45° C. and a hydroxyl number between 45 and 90.

20.) Coating composition according to one of the preceding claims, characterized in that the blocked aliphatic or cycloaliphatic polyisocyanate is a blocked isophorone diisocyanate (IPDI, 3,5,5-trimethyl-1-isocyanato-3-isocyanatomethylcy-clohexane) and/or 2,4,6-trioxo-1,3,5-tris(6-isocyanatohexyl)hexahydro-1,3,5-triazine present in trimerized or in biuret form.

21.) Use of a coating composition according to one of the preceding claims as clear coat, in particular in the automotive industry.

22.) Use of a coating composition according to one of the preceding claims for coating metal coils in the coil coating process.

23.) Use according to claim 22 for the production of a multilayer coating by
applying a primer layer to a pretreated metallic substrate and baking the same at a temperature between 180° C. and 260° C.;
applying a color-imparting base-coat layer and baking the same at a temperature between 180° C. and 260° C.;
applying a coating composition according to one of claims 1 to 19 and baking the same at a temperature between 180° C. and 260° C.

24.) Use according to claim 22 or 23 to produce automobile parts by deep drawing the metal coils precoated in the color of the vehicle.

25.) Use according to claim 23 or 24, characterized in that the layer thicknesses of the primer layer, the base-coat layer and the clear coat layer obtainable from the coating composition are each between 10 μm and 25 μm in the crosslinked state.
